(19) United States
(12) Patent Application Publication
(10) Pub. No.: US 2026/0161469 A1
(43) Pub. Date: Jun. 11, 2026

(54) METHOD TO OPTIMIZE STORAGE IO TAIL LATENCY WITH INITIATOR-BASED NAMESPACE RATE LIMITER USING PROGRAMMABLE PIPELINE

(71) Applicant: Advanced Micro Devices, Inc., Santa Clara, CA (US)

(72) Inventors: Xuyang WANG, Santa Clara, CA (US); Vishwas DANIVAS, Santa Clara, CA (US); Murty Subbaramachandra KOTHA, Santa Clara, CA (US)

(21) Appl. No.: 18/976,117

(22) Filed: Dec. 10, 2024

(51) Int. Cl. G06F 9/50

(52) U.S. Cl. CPC G06F 9/5038; G06F 9/5044

(57) ABSTRACT

A method includes determining, by a controller, whether to service a first work item of a plurality of work items stored in a retry ring circuitry within a buffer of a local host memory based on a difference between available resources and a quantity of resources necessary to service the first work item. The controller, based on determining that there is not a sufficient quantity of resources to service the first work item, compares a queuing delay of the first work item and a retry ring circuitry queuing delay, and adds a quantity of resources based on the comparing of the queuing delay of the first work item and the retry ring circuitry queuing delay.

### TECHNICAL FIELD

Examples herein relate to network accelerator circuitries. In particular, examples herein relate to network accelerator circuitry described herein providing NVMe virtualization with a reduced tail latency BACKGROUND

A network accelerator circuitry providing non-volatile memory express (NVMe) virtualization services exposes front end NVMe controller circuitries, submission queues (SQ) and completion queues (CQs) to local host circuitries. In the backend, the network accelerator circuitry connects remote NVMe storage targets and relays NVMe commands originated from the host circuitries to backend targets and generates completion messages to the local host circuitries when receiving responses from target devices. A typical network accelerator circuitry runs specially customized software implementing NVMe over fabric protocol on dedicated application specific integrated circuit (ASIC) circuitries on a data path pipeline of the network accelerator circuitry. The customized software fetches NVMe work items, such as queue entries (WQEs,) from host facing SQs, builds NVMe over fabric protocol data units (PDUs) and sends them to the local host circuitries.

Typically, a network accelerator circuitry virtualizing NVMe memory provides differentiated services to host tenants (virtual machines or containers) by applying various rate limit (RL) policies on either NVMe controller circuitries or NVMe namespaces (NS). In current NVMe production systems, input/output (IO) commands belonging to multiple NSs can be submitted to shared SQs. This presents challenges for NS RL solutions since typically, differentiated quality of services (QoS) are provided through multiple queues, while queue resources and associated memory resources needed to store IO command contexts are limited in devices. In a typical network accelerator circuitry, the token bucket algorithm is implemented in software to achieve NS RL. The token bucket algorithm is a mechanism in which an abstract container holds a certain amount of tokens, each token representing a unit of a resource. Each time a work item is to be serviced, a quantity of tokens is removed from the token bucket. If there are not enough tokens to service a work item, the work item request is rejected and is added to a tail of a retry ring circuitry while the tokens are refreshed. Problematically, although the tokens are being refreshed they are also being consumed by work items that are located closed to the head of the retry ring circuitry. This could cause a work item to be stuck in the retry ring circuitry for long periods of time and lead to high tail latency.

### SUMMARY

According to one or more examples, a method includes determining, by a controller, whether to service a first work item of a plurality of work items stored in a retry ring circuitry within a buffer of a local host memory based on a difference between available resources and a quantity of resources necessary to service the first work item, based on determining that there is not a sufficient quantity of resources to service the first work item, comparing, by the controller, a queuing delay of the first work item and a retry ring circuitry queuing delay, and adding, by the controller, a quantity of resources based on the comparing of the queuing delay of the first work item and the retry ring circuitry queuing delay.

According to one or more examples, a computer system includes a local host coupled to a local host memory, a controller coupled to the local host memory, wherein the controller is configured to determine whether to service a first work item of a plurality of work items stored in a retry ring circuitry within a buffer of the local host memory based on a difference between available resources and a quantity of resources necessary to service the first work item, based on determining that there is not a sufficient quantity of resources to service the first work item, compare a queuing delay of the first work item and a retry ring circuitry queuing delay, and add a quantity of resources based on the comparing of the queuing delay of the first work item and the retry ring circuitry queuing delay.

According to one or more examples, a controller coupled to a memory comprising a non-transitory computer readable medium configured to cause the controller to perform a method comprising: determining whether to service a first work item of a plurality of work items stored in a retry ring circuitry within a buffer of a local host memory that is coupled to the controller and a local host based on a difference between available resources and a quantity of resources necessary to service the first work item, wherein the first work item is located at a head of the retry ring circuitry, based on determining that there is not a sufficient quantity of resources to service the first work item, comparing a queuing delay of the first work item and a retry ring circuitry queuing delay; and adding a quantity of resources based on the comparing of the queuing delay of the first work item and the retry ring circuitry queuing delay.

### BRIEF DESCRIPTION OF DRAWINGS

FIG. 1 is a block diagram depicting a computer system according to an example.

FIG. 2 is a block diagram depicting a portion of the target system according to an example.

FIG. 3 illustrates a method for servicing work items corresponding to a command according one or more examples.

FIG. 4 illustrates a method for servicing work items corresponding to a command according one or more examples.

### DETAILED DESCRIPTION

As noted above, a network accelerator circuitry providing non-volatile memory express (NVMe) virtualization services exposes front end NVMe controller circuitries, submission queues (SQ) and completion queues (CQs) to local host circuitries. In the backend, the network accelerator circuitry connects remote NVMe storage targets and relays NVMe commands originated from the local host circuitries to the backend targets and generates completions to the local host circuitries when receiving responses from targets. A typical network accelerator circuitry runs specially customized software implementing NVMe over fabric protocol on dedicated application specific integrated circuit (ASIC) circuitries on a data path pipeline of the network accelerator circuitries. The customized software fetches NVMe work items such as work queue entries (WQEs) from host facing SQs, builds and transmits NVMe over fabric protocol data units (PDUs). In one or more examples, work items are work requests that need to be completed in order to complete a corresponding IO command. The advantage of this solution is that it can achieve low latency high throughput data transfer and scale to very large number of connections, while still obtaining the flexibility to upgrade features throughout the life cycle of a single generation of ASIC.

Typically, a network accelerator circuitry virtualizing NVMe storage provides differentiated services to host tenants (virtual machines or containers) by applying various rate limit (RL) policies on either NVMe controller circuitries or NVMe namespaces (NS). In current NVMe production systems, input/output (IO) commands belonging to multiple NSs can be submitted to shared SQs. This presents challenges for NS RL solutions, since typically, differentiated quality of services (QoS) are provided through multiple queues, while queue resources and associated memory resources needed to store IO command contexts are limited in devices. In a typical network accelerator circuitry, the token bucket algorithm is implemented in software to achieve NS RL. The token bucket algorithm is a mechanism in which an abstract container holds a certain amount of tokens, each token representing a unit of a resource. Each time a work item is to be serviced, a quantity of tokens is removed from the token bucket. Concurrently, the tokens are refreshed at a fixed interval refresh rate. The token bucket is limit to a maximum quantity of tokens. The token refresh rate and RL decision are both made when a work item corresponding to an IO command is provided from a local host device of the network accelerator circuitry. The number of tokens to be refreshed is determined by the configured rate and the elapsed time from the last time tokens are refreshed. A work item will be either rejected or serviced depending on whether there are enough tokens to service the work item. If it is rejected, the work item will be inserted at the tail of a first in first out (FIFO) retry ring circuitry (i.e., a buffer) located within a local host memory. A timer will be triggered to service work items in the retry ring circuitry, and the retried work item will be subjected to RL decision again when reaching the head of the retry ring circuitry. Each time a work item at the head of the retry ring circuitry fails the RL decision (i.e., there is not enough tokens), the work item will be re-injected back to the tail of the retry ring circuitry, thereby giving a chance for the other work items (possibly from a different NS) to get a chance to get serviced for execution. This leads to a problem of long tail latency and even starvation for IO commands. Stated differently, certain IO commands may never be completed before the IO command time out value because some work items can be potentially subjected to NS RL decisions multiple time, but still sent to the tail of the retry ring multiple times. Some NSs can potentially be requested multiple times but still be subjected to RL retry, if coincidently there are not enough tokens available each time it is evaluated in the retry ring circuitry. Problematically, the token bucket algorithm leads to high tail latency and IO command timeout due to work items being stuck in the retry ring circuitry for a period of time that is greater than the IO command timeout value. The token bucket algorithm degrades the performance of the computer system 100 because IO command timeout results in service disruption and long tail latency substantially impacts overall system performance and user experience.

The network accelerator circuitry described herein provides NVMe virtualization with a reduced tail latency while still achieving initiator-based NS RL design objectives without consuming additional device hardware resources and memory.

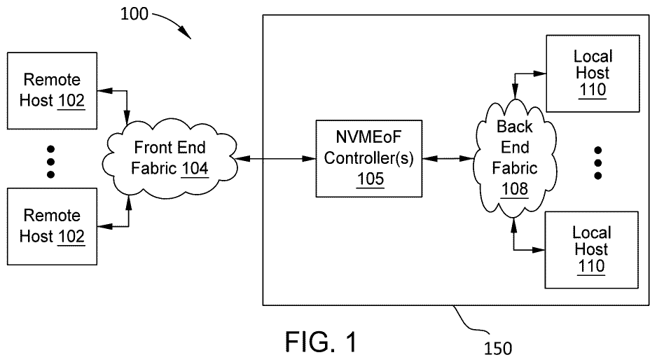

FIG. 1 is a block diagram depicting a computer system 100 according to an example. The computer system 100 includes one or more remote hosts 102, a back-end fabric 104, an NVMe-oF controller 105 (also referred to as “controller 105”), a front-end fabric 108, and one or more local hosts 110. For the purposes of clarity by example, a single NVMe-oF controller 105 is described. However, it is to be understood that the computer system 100 can include a plurality of NVMe-oF controllers 105.

The remote hosts 102 are coupled to the controller 105 through the back-end fabric 104. In one or more examples, a remote host 102 is a device or circuitry that is located remotely that is accessed by the controller 105 via the back-end fabric 104. The back-end fabric 104 can employ an Ethernet data link layer or InfiniBand® (IB) data link layer, among others. The remote hosts 102 can communicate with the controller 105 over the back-end fabric 104 using a remote direct memory access (RDMA) transport, such as RDMA over Converged Ethernet (ROCE), IB, Internet Wide Area RDMA (iWARP), or the like. The controller 105 is coupled to the local hosts 110 through the front-end fabric 108. In one or more examples, a local host 110 is a device or circuitry that is located locally that is accessed by the controller 105 via the front-end fabric 108. The front-end fabric 108 can employ a different transport than the back-end fabric 104. In an example, the front-end fabric 108 is a Peripheral Component Interconnect (PCI) Express® (PCIe) fabric. The controller 105 provides an interface between the remote hosts 102 and the local hosts 110. The controller 105 is coupled to the local hosts 110 through the front-end fabric 108. The local hosts 110 are configured to persistently store data using a NVM technology, such as solid state disk (SSD) storage technology.

In an example, the local hosts 110 includes a register interface compliant with an NVM Express® (NVMe) specification, such as NVM Express rev. 1.2. The controller 105, the front-end fabric 108, and the local hosts 110 are collectively referred to as a target system 150. The remote hosts 102 issue commands targeting the target system 150 using NVMe layered over RDMA transport. The controller 105 receives the commands and provides an interface between the different transports used by the back-end and front-end fabrics 104 and 108.

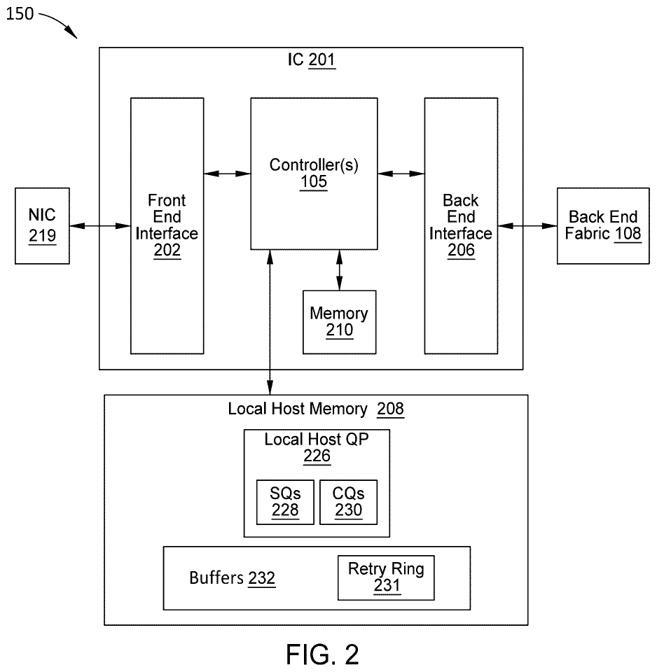

FIG. 2 is a block diagram depicting a portion of the target system 150 according to an example. The target system 150 includes an integrated circuit (IC) device 201. In an example, the IC device 201 is a programmable IC, such as a field programmable gate array (FPGA). Alternatively, the IC device 201 can be an application specific integrated circuit (ASIC). The IC device 201 includes a back-end interface 202, the controller 105, and a front-end interface 206. Although the IC device 201 is shown as having a single controller 105, the IC device 201 can include more than one controller 105. The back-end interface 202 can be coupled to a NIC circuitry 219, which in turn is coupled to the back-end fabric 104. In the example shown, the NIC circuitry 219 is external to the IC device 201. In other examples, the NIC circuitry 219 can be implemented within the IC device 201. The front-end interface 206 is configured for communication with one or more local hosts 110 through the front-end fabric 108. For example, the front-end interface 206 can be a PCIe fabric port. The controller 105 can interface with a local host memory 208 external to the IC device 201. In some examples, the controller 105 can also interface with a memory 210 implemented within the IC device 201 in addition to the local host memory 208.

The controller 105 provides an interface between the remote hosts 102 coupled to the back-end fabric 104 and the local hosts 110 coupled to the front-end fabric 108. The controller 105 also provides for flow control to control access among the remote hosts 102 to the limited resources of the shared memory. In this manner, the controller 105 can support a large number of remote hosts given limited memory resources.

The local host memory 208 includes local host queue pairs 226, a buffer 232. Although the local host memory 208 is described as including one buffer 232, the local host memory may include any suitable quantity of buffers. The local host memory 208 may store all or portions of one or more programs and/or data to implement aspects of the local hosts 110 described herein. The local host memory 208 can include one or more of random access memory (RAM), read only memory (ROM), magnetic read/write memory, FLASH memory, solid state memory, or the like as well as combinations thereof. The buffer 232 may be First-In-First-Out (FIFO) buffer. In other examples, the buffer 232 may be another type of buffer. In one or more examples, as will described in more detail below, the local host(s) 110 sends a command to the local host memory 208 by providing at least one work item corresponding to a namespace to submission queues (SQs) 228 of the local host memory 208. The local host(s) 110 rings a door bell on the SQs 228 (i.e., sends a signal to the SQs 228) which informs the controller 105 that a command has been sent. In one or more examples, the command is an input output (IO) command. The controller 105 fetches the at least one work item from the SQs 228. The controller 105 fetches the work items from the SQs in a FIFO manner and determines, based on available resources to the controller 105, whether a work item can be serviced. If a work item can be serviced, the controller 105 services the work item by generating an NVMe-over fabric PDU and sends the PDU to the corresponding local host 110 via the front-end interface 206 and the front-end fabric 108. On the other hand, each work item that cannot be serviced is sent to the tail of a retry ring circuitry 231 included in the buffer 232. In one or more examples, the work items are work queue entries (WQEs).

In one or more examples, the local host memory 208 includes completion queues (CQs) 230. The local hosts 110 can maintain SQs 228 and CQs 230 in the local host memory 208. Upon a local host 110 receiving an NVMe-over fabric PDU corresponding to a work item, the local host 110 provides a completion queue entry (CQE) to the controller 105 and the controller 105 provides the CQE to the CQs indicating that the work item has been completed.

In one or more examples, the resources available to the controller 105 are updated based on resources consumed to service a work item and the resource refresh rate of the controller 105. The resources available to the controller 105 are defined herein as tokens. Typically, the controller 105 fetches work items at the head of the retry ring circuitry 231 of the buffer 232 in a FIFO manner. The typical controller 105 services work items using the token bucket algorithm. The token bucket algorithm involves the controller 105 determining whether the controller 105 can service a work item located at the head of the retry ring circuitry 231 based on the available quantity of tokens. If the controller 105 determines the quantity of available tokens is greater than or equal to the quantity of tokens consumed by the work item, the controller 105 will service the work item and the quantity of tokens consumed by the work item are removed. On the other hand, if the controller 105 determines the quantity of available tokens is less than the quantity of tokens consumed by the work item, the controller 105 sends the work item to the tail of the retry ring circuitry 231. Concurrently, the quantity of tokens available to the controller 105 is refreshed by the controller 105 at a refresh (refill) rate until the quantity of token reaches a maximum token value. Stated differently, the tokens are refilled at a fixed interval as the controller 105 evaluates the work items in the retry ring circuitry 231. Problematically, due to the tokens being refreshed at a fixed time and as work items from other commands (namespaces) are added to the retry ring circuitry 231, some work items may become stuck in the retry ring circuitry 231.

Embodiments herein relate to a method for servicing work items that are included in a retry ring circuitry 231 in the buffer 232 in which work items with longer queuing delays (time spend within the buffer) are prioritized by adding additional resources for work items based on their queueing delay versus the moving average of the queuing delays of all the work items included in the retry ring circuitry 231.

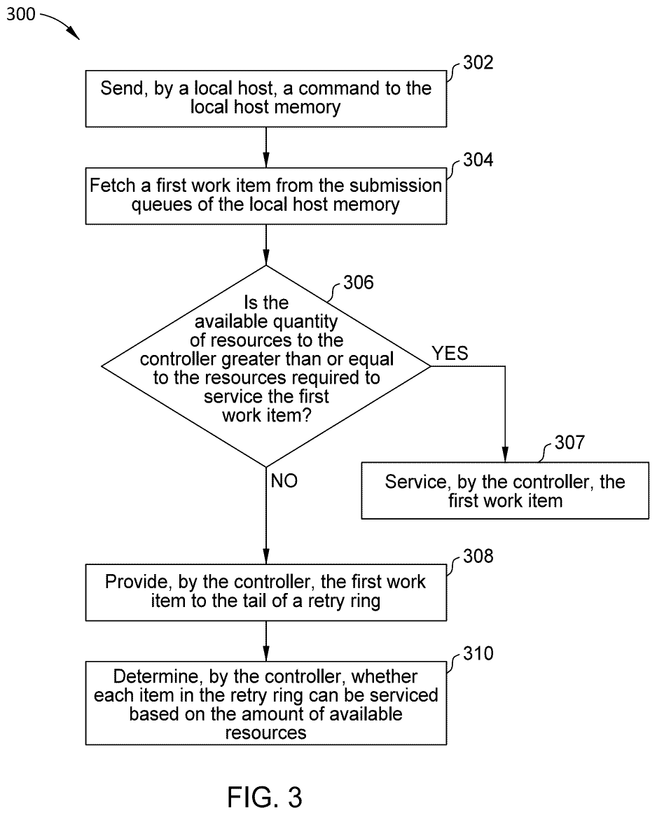

FIG. 3 illustrates a method 300 for servicing work items corresponding to a command according one or more examples. As noted above, the command and the work items are provided by a local host 110 and the work items are serviced by the controller 105. In one or more examples, the memory 210 includes a non-transitory computer readable medium that includes instructions stored therein, and the controller 105 executes the instructions to perform the method 300.

At operation 302 of the method 300, a local host 110 sends a command to the local host memory 208 via the front-end fabric 108. In one or more examples, the command is an IO command. In one or more examples, the local host 110 sends the command by generating a plurality of work items and providing the plurality of work items corresponding to a namespace to an SQ 228 of the local host memory 208. In one or more examples, the local host 110 sends the plurality of work items to multiple SQs 228. In one or more examples, as described above, the works items are WQEs. Then the local host 110 rings a door bell on the SQ 228 (or SQs 228) indicating to the controller 105 that a command has been sent. In examples, in which there are multiple SQs 228 that receive work items, the local host 110 rings a doorbell on each individual SQ 228 that receives a work item.

At operation 304 of the method 300, the controller 105 fetches (i.e., evaluates) a first work item from the SQs 228 of the local host memory 208.

At operation 306 of the method 300, the controller 105 determines whether the available quantity of resources (tokens) available to the controller 105 is greater than or equal to the resources necessary to service the work item. If the quantity of available resources to the controller 105 is not greater than or equal to (i.e., less than) the resources necessary to service the first work item, the operation proceeds to operations 308-310. {Inventors please confirm this paragraph is correct}

At operation 308 of the method 300 the controller 105 provides the first work item to the tail of the retry ring circuitry 231 included in the buffer 232. In one or more examples, the controller 105 saves the work item in a memory of the NIC circuitry 219.

Then the controller 105 provides the work item to the tail of the retry ring circuitry 231 by providing on a unique identifier of the work item to the tail of the retry ring circuitry 231. Thus, when the controller 105 is able to execute the work item, the work item can be retrieved from the NIC circuitry 219.

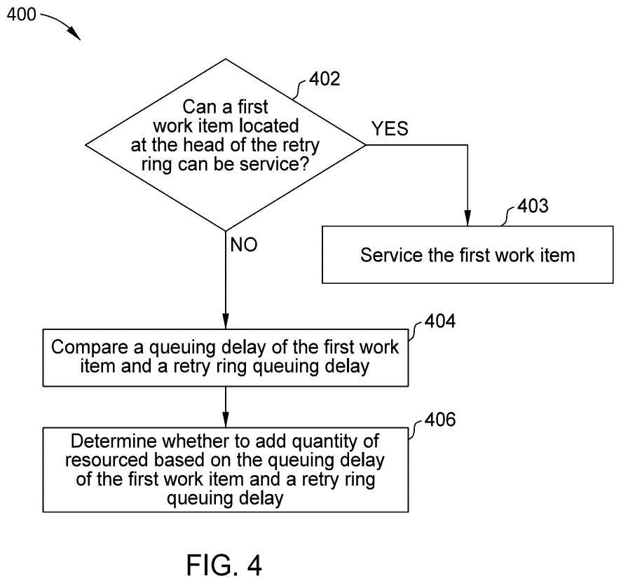

At operation 310 of the method 300 determines whether each work item in the retry ring circuitry 231 can be serviced based on the amount of resources available to the controller 105, the amount of resources necessary to service each work item and whether to add additional resources (in addition to the resources added via the refresh rate) based on a queue time of each work item and a retry ring circuitry queue time. This is described in more detail in method 400 of FIG. 4 described below.

On the other hand, if the quantity of available resources to the controller 105 is greater than or equal to the resources necessary to service the first work item, the method proceeds to operation 307 and the controller services the first work item. As noted above, the controller 105 services the first work item by generating an NVMe-over fabric PDU based on the first work item and sends the PDU back to the local host 110 via the front-end interface 206 and the front-end fabric 108. Then the local host 110 provides a CQE to the CQs 230 of the local host memory 208. Upon servicing the first work item, the resources necessary to service the first work item are subtracted from the available quantity of resources available to the controller 105. As understood by those with ordinary skill in the art the resources available to the controller 105 are refreshed (refilled) throughout the method 300 (and the method 400 in FIG. 4) at a refresh rate. In one or more examples, the refresh rate is from about 4,000 to about 2,000,000 IOPS per second.

FIG. 4 illustrates a method 400 for servicing work items corresponding to a command according one or more examples. As noted above, the command and the work items are provided by a local host 110 and the work items are serviced by the controller 105. In one or more examples, the memory 210 includes a non-transitory computer readable medium that includes instructions, the instructions when executed by the controller 105 cause the controller 105 to perform the method 400.

At operation 402, the controller 105 determines whether a first work item (i.e., a WQE) that is located at the head of the retry ring circuitry 231 can be serviced.

The controller 105 determines whether the first work item that is located at the head of the retry ring circuitry 231 can be serviced based on a difference between the available resources to the controller 105 and a quantity of resources necessary to service the first work item. If the controller 105 determines that the quantity of resources necessary to service the first work item is greater than or equal to the available resources to the controller 105 the method 400 proceeds to operation 403 and the controller 105 services the first work item. Operation 403 is performed in the same manner as operation 307 of the method 300.

On the other hand, if the controller 105 determines that the quantity of resources necessary to service the first work item is less than to the available resources to the controller 105, the method 400 proceeds to operation 403 and the method proceeds to operation 404.

At operation 404 of the method 400, the controller 105 compares a queuing delay of the first work item and a retry ring circuitry queuing delay. In one or more examples, the queuing delay of the first work item is a duration of time that has elapsed since the controller fetched the first work item (i.e., operation 304) from the SQs 228. The retry ring circuitry queuing delay is the moving average of a duration of time elapsed since the controller 105 fetched each work item included in the retry ring circuitry 231 of the buffer 232.

At operation 406 of the method 400, the controller 105 determines whether to add a quantity of resources based on the comparing of the queuing delay of the work item and the retry ring circuitry queuing delay. If the controller 105 determines that the queuing delay of the first work item in the retry ring circuitry 231 is less than half of the retry ring circuitry queuing delay, the controller 105 adds a first quantity of resources. If the controller 105 determines that the queuing delay of the first work item in the retry ring circuitry 231 is greater than or equal to half of the retry ring circuitry queuing delay and less than double the retry queuing delay, the controller 105 adds a second quantity of resources. If the controller 105 determines that the queuing delay of the first work item in the retry ring circuitry 231 is greater than or equal to double the retry ring circuitry queuing delay, the controller adds a third quantity of resources. The first quantity of resources less than the second quantity of resources. The second quantity of resources is less than the third quantity of resources. The quantities of resources are determined based on the smallest possible input output operations per second (IOPS) of the local host memory 208, and the target rate of the namespace that the command that the work item being evaluated by the controller 105 belongs to. For example, the first quantity of resources is determined by multiplying a first integer with the a ratio between the currently configured rate of the namespace and the smallest possible rate. The second quantity of resources is determined by multiplying a second integer with a ratio between the currently configured rate of the namespace and the smallest possible rate. The third quantity of resources is determined by multiplying a third integer with a ratio between the currently configured rate of the namespace and the smallest possible rate. The first integer is less than the second integer which is less than the third integer. The first integer may be from about 0.5 to about 1, for example 1. The second integer may be from about 1.5 to about 2.5, for example 2. The third integer may be from about 3 to about 5, for example 4.

Advantageously, because the third quantity of resources (and the third integer) is greater than the second quantity of resources (and the second integer), and the second quantity of resources is greater than the first quantity of resources (the first integer) the work items with the longest delays (the work items that have been in the retry ring circuitry 231 the longest) and/or the highest traffic rates are given more chances to be serviced, thus preventing work items from being stuck in the retry ring circuitry 231.

In one or more examples, after adding the quantity of resources, if there are enough resources to service the first work item, the controller 105 services the first work item as described in operation 403 above. If there is still not enough resources available to the controller 105, the controller 105 moves the first work item to the tail of the retry ring circuitry 231 and performs the method 400 on the next work item in the retry ring circuitry 231.

As noted above the work items corresponding to a command corresponding to a namespace remain in the retry ring circuitry 231 until each work item corresponding to the command is serviced. Concurrently, the retry ring circuitry 231 may include work items corresponding to commands to other namespaces of the local hosts. If the token bucket algorithm is used, operations may never be completed because the workspace may be stuck in the retry ring circuitry 231 indefinitely. However, by specifically adding resources that are available to the controller 105 based on the duration of time a work item has been in the retry ring circuitry 231 causes work items that have spent a longer time in the retry ring circuitry 231 to be prioritized, thus, preventing work items from being stuck in the retry ring circuitry 231. In one or more examples, the method 400 is repeated for each work item located in the retry ring circuitry 231.

Advantageously, in lieu, of using the token bucket algorithm, in which resources are only added at a fixed interval the controller 105 determines whether to add resources while evaluating work items in the retry ring circuitry 231 based on the queueing delays the work items versus the moving average of the queuing delays of all the work items included in the retry ring circuitry 231. This allows for work items with longer queuing delays to be prioritized thus providing a reduced tail latency while still achieving design objectives without consuming additional device hardware resources and memory.

While the foregoing is directed to specific examples, other and further examples may be devised without departing from the basic scope thereof, and the scope thereof is determined by the claims that follow.

What is claimed is:

1. A method comprising:
determining, by a controller, whether to service a first work item of a plurality of work items stored in a retry ring circuitry within a buffer of a local host memory based on a difference between available resources and a quantity of resources necessary to service the first work item;
based on determining that there is not a sufficient quantity of resources to service the first work item, comparing, by the controller, a queuing delay of the first work item and a retry ring circuitry queuing delay; and
adding, by the controller, a quantity of resources based on the comparing of the queuing delay of the first work item and the retry ring circuitry queuing delay.

2. The method of claim 1, wherein the retry ring circuitry queuing delay is a moving average of a duration of time elapsed since the controller fetched each work item in the retry ring circuitry and the queuing delay of the first work item is a duration of time since the controller fetched the first work item.

3. The method of claim 1, further comprising
providing, by a local host, a command to the local host memory, wherein providing the command from the local host comprises sending a second work item corresponding to the command to a submission queue (SQ) of the local host memory;
fetching, by the controller, the second work item from the SQ that corresponds to the command from the local host;
determining, by the controller, to service the second work item based on a quantity of the available resources; and
adding, by the controller, the second work item to a tail of the retry ring circuitry based on determining that the quantity of available resources is less than the quantity of resources necessary to service the second work item.

4. The method of claim 1, further comprising adding a first quantity of resources if the queuing delay is less than half of the retry ring circuitry queuing delay.

5. The method of claim 4, further comprising adding a second quantity of resources if the queuing delay is greater than or equal to half of the retry ring circuitry queuing delay and less than double the retry ring circuitry queuing delay.

6. The method of claim 5, further comprising adding a third quantity of resources if the queuing delay is greater than or equal double the retry ring circuitry queuing delay.

7. The method of claim 6, wherein the first quantity of resources is less than the second quantity of resources, and the second quantity of resources is less than the third quantity of resources.

8. A computer system comprising:
a local host coupled to a local host memory;
a controller coupled to the local host memory, wherein the controller is configured to:
determine whether to service a first work item of a plurality of work items stored in a retry ring circuitry within a buffer of the local host memory based on a difference between available resources and a quantity of resources necessary to service the first work item;
based on determining that there is not a sufficient quantity of resources to service the first work item, compare a queuing delay of the first work item and a retry ring circuitry queuing delay; and
add a quantity of resources based on the comparing of the queuing delay of the first work item and the retry ring circuitry queuing delay.

9. The computer system of claim 8, wherein the local host is further configured to provide a command to the local host memory, wherein providing the command from the local host comprises sending a second work item corresponding to the command to a submission queue (SQ) of the local host memory, and the controller is further configured to:
fetch the second work item from the SQ that corresponds to the command from the local host;
determine whether to service the second work item based on a quantity of the available resources; and
add the second work item to a tail of the retry ring circuitry based on determining on determining that the quantity of available resources is less than the quantity of resources necessary to service the second work item.

10. The computer system of claim 8, wherein the controller is further configured to add a first quantity of resources if the queuing delay is less than half of the retry ring circuitry queuing delay.

11. The computer system of claim 10, wherein the controller is further configured to add a second quantity of resources if the queuing delay is greater than or equal to half of the retry ring circuitry queuing delay and less than double the retry ring circuitry queuing delay.

12. The computer system of claim 11, wherein the controller is configured to add a third quantity of resources if the queuing delay is greater than or equal double the retry ring circuitry queuing delay.

13. The computer system of claim 12, wherein the first quantity of resources is less than the second quantity of resources, and the second quantity of resources is less than the third quantity of resources.

14. A controller coupled to a memory comprising a non-transitory computer readable medium configured to cause the controller to perform a method comprising:
determining whether to service a first work item of a plurality of work items stored in a retry ring circuitry within a buffer of a local host memory that is coupled to the controller and a local host based on a difference between available resources and a quantity of resources necessary to service the first work item, wherein the first work item is located at a head of the retry ring circuitry;
based on determining that there is not a sufficient quantity of resources to service the first work item, comparing a queuing delay of the first work item and a retry ring circuitry queuing delay; and
adding a quantity of resources based on the comparing of the queuing delay of the first work item and the retry ring circuitry queuing delay.

15. The controller of claim 14, wherein the retry ring circuitry queuing delay is a moving average of a duration of time elapsed since the controller fetched each work item in the retry ring circuitry and the queuing delay of the first work item is a duration of time since the controller fetched the first work item.

16. The controller of claim 14, wherein the method further comprises:
fetching a second work item a submission queue (SQ) of the local host memory, wherein the second work item is provided to the SQ from the local host;
determining whether to service the second work item based on a quantity of the available of resources; and
adding the second work item to a tail of the retry ring circuitry based on determining on determining that the quantity of available resources is less than the quantity of resources necessary to service the second work item.

17. The controller of claim 14, wherein the controller adds a first quantity of resources if the queuing delay is less than half of the retry ring circuitry queuing delay.

18. The controller of claim 17, wherein the controller adds a second quantity of resources if the queuing delay is greater than or equal to half of the retry ring circuitry queuing delay and less than double the retry ring circuitry queuing delay.

19. The controller of claim 18, wherein the controller adds a third quantity of resources if the queuing delay is greater than or equal double the retry ring circuitry queuing delay.

20. The controller of claim 19, wherein the first quantity of resources is less than the second quantity of resources, and the second quantity of resources is less than the third quantity of resources.
